(19) United States
(12) Patent Application Publication
(10) Pub. No.: US 2022/0074886 A1
(43) Pub. Date: Mar. 10, 2022

(54) LIMITING CURRENT GAS SENSOR AND MANUFACTURING METHOD THEREOF

(71) Applicant: ROHM Co., LTD., Kyoto (JP)

(72) Inventor: Shunsuke Akasaka, Kyoto (JP)

(21) Appl. No.: 17/465,941

(22) Filed: Sep. 3, 2021

(30) Foreign Application Priority Data
Sep. 8, 2020 (JP) 2020-150279

(51) Int. Cl. G01N 27/407; G01N 27/409

(52) U.S. Cl. CPC G01N 27/4073; G01N 27/409

(57) ABSTRACT

Provided is a limiting current gas sensor including a first porous electrode including a main surface; a plurality of solid electrolyte islands provided on the main surface of the first porous electrode and separated from each other; and a second porous electrode provided on the plurality of solid electrolyte islands, in which the first porous electrode is provided across the plurality of solid electrolyte islands, the second porous electrode is provided across the plurality of solid electrolyte islands, and a maximum size of each of the plurality of solid electrolyte islands in plan view of the main surface is equal to or smaller than 50√2 μm.

### CROSS REFERENCE TO RELATED APPLICATIONS

This application claims priority benefit of Japanese Patent Application No. JP 2020-150279 filed in the Japan Patent Office on Sep. 8, 2020. Each of the above-referenced applications is hereby incorporated herein by reference in its entirety.

### BACKGROUND

The present disclosure relates to a limiting current gas sensor and a manufacturing method thereof.

A limiting current oxygen sensor is disclosed in FIG. 6 of Japanese Patent Laid-Open No. Sho 59-166854. The limiting current oxygen sensor includes an insulating substrate, a gas-permeable first electrode, a thin-film solid electrolyte, and a gas-permeable second electrode. The first electrode, the thin-film solid electrolyte, and the second electrode are sequentially layered on the insulating substrate. Each of the first electrode and the second electrode is formed by platinum or palladium. An oxygen gas goes through the first electrode and is converted into oxygen ions. The oxygen ions are conducted through the thin-film solid electrolyte and move to the second electrode.

In the limiting current oxygen sensor of Japanese Patent Laid-Open No. Sho 59-166854, accurate concentration of the gas to be measured may not be obtained on the basis of the limiting current value output from the limiting current oxygen sensor. The present disclosure has been made in view of the problem, and it is desirable to provide a limiting current gas sensor that can obtain more accurate concentration of gas to be measured.

### SUMMARY

A limiting current gas sensor of the present disclosure includes a first porous electrode, a plurality of solid electrolyte islands, and a second porous electrode. The first porous electrode includes a main surface. The plurality of solid electrolyte islands are provided on the main surface of the first porous electrode and separated from each other. The second porous electrode is provided on the plurality of solid electrolyte islands. The first porous electrode is provided across the plurality of solid electrolyte islands. The second porous electrode is provided across the plurality of solid electrolyte islands. A maximum size of each of the plurality of solid electrolyte islands in plan view of the main surface of the first porous electrode is equal to or smaller than 50√2 μm.

A manufacturing method of a limiting current gas sensor of the present disclosure includes forming a first porous electrode including a main surface; forming a plurality of solid electrolyte islands separated from each other, on the main surface of the first porous electrode; and forming a second porous electrode on the plurality of solid electrolyte islands. The first porous electrode is formed across the plurality of solid electrolyte islands. The second porous electrode is formed across the plurality of solid electrolyte islands. A maximum size of each of the plurality of solid electrolyte islands in plan view of the main surface of the first porous electrode is equal to or smaller than 50√2 μm.

According to the limiting current gas sensor and the manufacturing method thereof of the present disclosure, more accurate concentration of gas to be measured can be obtained.

### BRIEF DESCRIPTION OF THE DRAWINGS

FIG. 1 is a schematic partial cross-sectional view of a limiting current gas sensor according to an embodiment;

FIG. 2 is a schematic partial plan view of the limiting current gas sensor according to the embodiment;

FIG. 3 is a schematic cross-sectional view illustrating a process in a manufacturing method of the limiting current gas sensor according to the embodiment;

FIG. 4 is a schematic cross-sectional view illustrating a process following the process illustrated in FIG. 3 in the manufacturing method of the limiting current gas sensor according to the embodiment;

FIG. 5 is a schematic cross-sectional view illustrating a process following the process illustrated in FIG. 4 in the manufacturing method of the limiting current gas sensor according to the embodiment;

FIG. 6 is a schematic cross-sectional view illustrating a process following the process illustrated in FIG. 5 in the manufacturing method of the limiting current gas sensor according to the embodiment;

FIG. 7 is a schematic cross-sectional view illustrating a process following the process illustrated in FIG. 6 in the manufacturing method of the limiting current gas sensor according to the embodiment;

FIG. 8 is a schematic cross-sectional view illustrating a process following the process illustrated in FIG. 7 in the manufacturing method of the limiting current gas sensor according to the embodiment;

FIG. 9 is a schematic cross-sectional view illustrating a process following the process illustrated in FIG. 8 in the manufacturing method of the limiting current gas sensor according to the embodiment;

FIG. 10 is a schematic cross-sectional view illustrating a process following the process illustrated in FIG. 9 in the manufacturing method of the limiting current gas sensor according to the embodiment;

FIG. 11 is a schematic cross-sectional view illustrating a process following the process illustrated in FIG. 10 in the manufacturing method of the limiting current gas sensor according to the embodiment;

FIG. 12 is a schematic cross-sectional view illustrating a process following the process illustrated in FIG. 11 in the manufacturing method of the limiting current gas sensor according to the embodiment;

FIG. 13 is a schematic cross-sectional view illustrating a process following the process illustrated in FIG. 12 in the manufacturing method of the limiting current gas sensor according to the embodiment;

FIG. 14 is a circuit diagram of the limiting current gas sensor according to the embodiment;

FIG. 15 depicts a scanning electron microscope (SEM) photo of the surface of a solid electrolyte layer in a first comparison example annealed at a temperature of 700° C.;

FIG. 16 depicts an SEM photo of the surface of one of a plurality of solid electrolyte islands in a second comparison example annealed at the temperature of 700° C.;

FIG. 17 depicts an SEM photo of the surface of one of a plurality of solid electrolyte islands in the embodiment annealed at the temperature of 700° C.; and

FIG. 18 is a schematic partial plan view of the limiting current gas sensor according to a modification of the embodiment.

### DETAILED DESCRIPTION OF THE PREFERRED EMBODIMENT

An embodiment will now be described. Note that the same reference numbers are provided to the same components, and the description will not be repeated.

### Embodiment

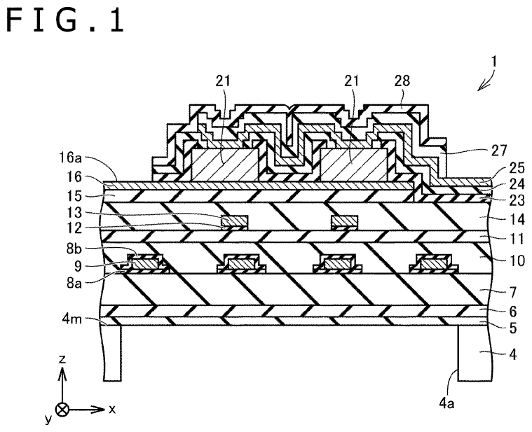

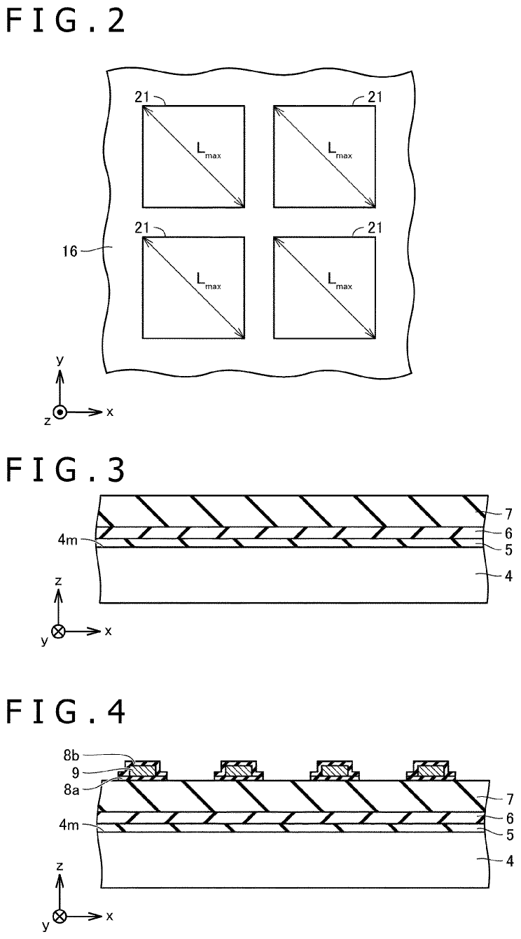

A limiting current gas sensor 1 of the embodiment will be described with reference to FIGS. 1 and 2. The limiting current gas sensor 1 can measure, for example, the concentration of nitrogen oxides (NOₓ) included in a gas to be measured, such as exhaust gas of a car. The limiting current gas sensor 1 can measure, for example, the concentration of oxygen (O₂) included in the gas to be measured or the concentration of water vapor (H₂O) included in the gas to be measured.

The limiting current gas sensor 1 mainly includes a first porous electrode 16, a plurality of solid electrolyte islands 21, and a second porous electrode 25. The limiting current gas sensor 1 may further include a gas introduction path 15 and a gas discharge path 27. The limiting current gas sensor 1 may further include a substrate 4, a heater 9, a temperature sensor 13, insulating layers 5, 7, 10, 14, 23, 24, and 28, nitride layers 6 and 11, and adhesive layers 8a, 8b, and 12.

The substrate 4 is a silicon substrate but is not particularly limited thereto. The thickness of the substrate 4 is, for example, equal to or smaller than 2 μm. Thus, the heat capacity of the substrate 4 can be small, and the power consumption of the heater 9 can be reduced. The substrate 4 includes a main surface 4m. An opening 4a is provided on the substrate 4. The opening 4a of the substrate 4 is extended to the main surface 4m of the substrate 4, and the contact area between the substrate 4 and the insulating layer 5 is reduced.

The heater 9 heats the plurality of solid electrolyte islands 21 to allow ionic conduction in the plurality of solid electrolyte islands 21. The heater 9 is provided on the main surface 4m of the substrate 4. The heater 9 may be meandering in plan view of the main surface 4m of the substrate 4, and the heater 9 may be a meander heater wire. The heater 9 is surrounded by an edge of the opening 4a in plan view of the main surface 4m of the substrate 4. Thus, the heat generated by the heater 9 is not easily dispersed to the substrate 4, and the heat can be efficiently applied to the plurality of solid electrolyte islands 21.

Specifically, the insulating layer 5 is provided on the main surface 4m of the substrate 4. The insulating layer 5 is formed by, for example, silicon dioxide (SiO₂). The nitride layer 6 is provided on the insulating layer 5. The nitride layer 6 is formed by, for example, silicon nitride (Si₃N₄). The insulating layer 7 is provided on the nitride layer 6. The insulating layer 7 is formed by, for example, silicon dioxide (SiO₂). The insulating layers 5 and 7 and the nitride layer 6 electrically insulate the heater 9 from the substrate 4.

The heater 9 is formed on the insulating layer 7. The heater 9 is a thin-film heater formed by, for example, platinum. The insulating layer 10 is provided on the insulating layer 7 and the heater 9. The heater 9 is embedded into the insulating layer 10. The insulating layer 10 is formed by, for example, silicon dioxide (SiO₂). The heater 9 may be covered by the adhesive layers 8a and 8b in the cross section perpendicular to the longitudinal direction of the heater 9. The adhesive layer 8a is provided between the insulating layer 7 and the heater 9. The adhesive layer 8a improves the adhesion of the heater 9 to the insulating layer 7. The adhesive layer 8b is provided between the heater 9 and the insulating layer 10. The adhesive layer 8b improves the adhesion of the heater 9 to the insulating layer 10.

The adhesive layers 8a and 8b are formed by metal oxides. The adhesive layers 8a and 8b are formed by, for example, transition metal oxides, such as titanium oxide, chromium oxide, tungsten oxide, molybdenum oxide, and tantalum oxide. Each of the adhesive layers 8a and 8b includes an oxygen deficient region in which oxygen is deficient in terms of stoichiometric ratio between metal and oxygen. The oxygen deficient regions are present at parts of the adhesive layers 8a and 8b near the interfaces between the heater 9 and the adhesive layers 8a and 8b. This improves the adhesion of the adhesive layers 8a and 8b to the heater 9. The amount of oxygen in the oxygen deficient regions may be equal to or greater than 30% but equal to or smaller than 80% of the amount of oxygen in the stoichiometric composition of the metal oxides forming the adhesive layers 8a and 8b, may be equal to or greater than 40% but equal to or smaller than 75% of the amount of oxygen in the stoichiometric composition of the metal oxides forming the adhesive layers 8a and 8b, or may be equal to or greater than 45% but equal to or smaller than 70% of the amount of oxygen in the stoichiometric composition of the metal oxides forming the adhesive layers 8a and 8b.

The stoichiometric ratio between metal and oxygen in the metal oxides forming the adhesive layers 8a and 8b may be greater than 1.0:0.5 but equal to or smaller than 1.0:1.5, may be equal to or greater than 1.0:0.6 but equal to or smaller than 1.0:1.5, or may be equal to or greater than 1.0:0.9 but equal to or smaller than 1.0:1.4.

The nitride layer 11 is provided on the insulating layer 10. The nitride layer 11 is formed by, for example, silicon nitride (Si₃N₄). The temperature sensor 13 is formed on the nitride layer 11. The temperature sensor 13 is, for example, a thin-film temperature sensor formed by platinum. The insulating layer 10 and the nitride layer 11 electrically insulate the temperature sensor 13 from the substrate 4 and the heater 9. The insulating layer 14 is provided on the nitride layer 11 and the temperature sensor 13. The temperature sensor 13 is embedded into the insulating layer 14. The insulating layer 14 protects the temperature sensor 13. The insulating layer 14 is formed by, for example, silicon dioxide (SiO₂). The adhesive layer 12 is provided between the nitride layer 11 and the temperature sensor 13. The adhesive layer 12 improves the adhesion of the temperature sensor 13 to the nitride layer 11.

The adhesive layer 12 is formed by metal oxides. The adhesive layer 12 is formed by, for example, transition metal oxides, such as titanium oxide, chromium oxide, tungsten oxide, molybdenum oxide, and tantalum oxide. The adhesive layer 12 includes an oxygen deficient region in which oxygen is deficient in terms of stoichiometric ratio between metal and oxygen. The oxygen deficient region is present at a part of the adhesive layer 12 near the interface between the temperature sensor 13 and the adhesive layer 12. This improves the adhesion of the adhesive layer 12 to the temperature sensor 13. The amount of oxygen in the oxygen deficient region may be equal to or greater than 30% but equal to or smaller than 80% of the amount of oxygen in the stoichiometric composition of the metal oxides forming the adhesive layer 12, may be equal to or greater than 40% but equal to or smaller than 75% of the amount of oxygen in the stoichiometric composition of the metal oxides forming the adhesive layer 12, or may be equal to or greater than 45% but equal to or smaller than 70% of the amount of oxygen in the stoichiometric composition of the metal oxides forming the adhesive layer 12.

The stoichiometric ratio between metal and oxygen in the metal oxides forming the adhesive layer 12 may be greater than 1.0:0.5 but equal to or smaller than 1.0:1.5, may be equal to or greater than 1.0:0.6 but equal to or smaller than 1.0:1.5, or may be equal to or greater than 1.0:0.9 but equal to or smaller than 1.0:1.4.

The gas introduction path 15 is provided on the insulating layer 14. The gas introduction path 15 is extended from an inlet (not illustrated) of the gas to be measured to a part of the first porous electrode 16 facing the plurality of solid electrolyte islands 21. The gas introduction path 15 may be formed by a first porous transition metal oxide with a second melting point higher than a first melting point of the first porous electrode 16. The gas introduction path 15 may be formed by a first porous transition metal oxide with a second melting point higher than a third melting point of the second porous electrode 25. In the present specification, the transition metals denote elements from group 3 to group 11 in the long form of periodic table of elements of the International Union of Pure and Applied Chemistry (IUPAC). The first porous transition metal oxide is, for example, tantalum pentoxide (Ta₂O₅), titanium dioxide (TiO₂), or chromium oxide (III) (Cr₂O₃).

The first porous electrode 16 is provided on the gas introduction path 15. The first porous electrode 16 is provided between the plurality of solid electrolyte islands 21 and the gas introduction path 15. The first porous electrode 16 is provided across the plurality of solid electrolyte islands 21. The first porous electrode 16 is in contact with each of the plurality of solid electrolyte islands 21. Particularly, the first porous electrode 16 is in contact with a lower surface of each of the plurality of solid electrolyte islands 21. The lower surface of each of the plurality of solid electrolyte islands 21 is a surface of each of the plurality of solid electrolyte islands 21 proximal to the first porous electrode 16 or distal to the second porous electrode 25. The first porous electrode 16 includes a main surface 16a. The main surface 16a of the first porous electrode 16 is an upper surface of the first porous electrode 16 proximal to the plurality of solid electrolyte islands 21. The first porous electrode 16 easily passes the gas to be measured toward the plurality of solid electrolyte islands 21. The first porous electrode 16 is formed by, for example, platinum (Pt) or palladium (Pd).

The plurality of solid electrolyte islands 21 are provided on the main surface 16a of the first porous electrode 16. The plurality of solid electrolyte islands 21 are formed by ionic conductors, such as oxygen ion conductors, in which a stabilizer, such as CaO, MgO, Y₂O₃, and Yb₂O₃, is added to a base material, such as ZrO₂, HfO₂, ThO₂, and Bi₂O₃. The plurality of solid electrolyte islands 21 are formed by, for example, yttria stabilized zirconia (YSZ) or (La, Sr, Ga, Mg, Co) 03. The plurality of solid electrolyte islands 21 exhibit ionic conductivity when heated by the heater 9. The plurality of solid electrolyte islands 21 are heated at a temperature of, for example, equal to or higher than 400° C. but equal to or lower than 750° C. during the operation of the limiting current gas sensor 1.

Each of the plurality of solid electrolyte islands 21 has a thickness of, for example, equal to or smaller than 2.0 μm. Each of the plurality of solid electrolyte islands 21 has a thickness of, for example, equal to or greater than 0.8 μm. The plurality of solid electrolyte islands 21 are separated from each other. Each of the plurality of solid electrolyte islands 21 may have, for example, a square or rectangular shape (see FIG. 2) or may have a round shape (see FIG. 18) in plan view of the main surface 16a of the first porous electrode 16. The plurality of solid electrolyte islands 21 may be two-dimensionally and periodically arranged in plan view of the main surface 16a of the first porous electrode 16. The plurality of solid electrolyte islands 21 may be arranged in, for example, a grid pattern or a staggered pattern in plan view of the main surface 16a of the first porous electrode 16.

A maximum size Lₘₐₓ of each of the plurality of solid electrolyte islands 21 in plan view of the main surface 16a of the first porous electrode 16 is equal to or smaller than 50√2 μm. The maximum size Lₘₐₓ of each of the plurality of solid electrolyte islands 21 in plan view of the main surface 16a of the first porous electrode 16 may be equal to or smaller than 50 μm or may be equal to or smaller than 30 μm. In the present specification, the maximum size Lₘₐₓ of each of the plurality of solid electrolyte islands 21 in plan view of the main surface 16a of the first porous electrode 16 is defined as a maximum length among the lengths of a plurality of lines connecting any two points of each of the plurality of solid electrolyte islands 21 in plan view of the main surface 16a of the first porous electrode 16.

For example, as illustrated in FIG. 2, when each of the plurality of solid electrolyte islands 21 has a square shape, the maximum size Lₘₐₓ of each of the plurality of solid electrolyte islands 21 is the length of the diagonal of each of the plurality of solid electrolyte islands 21. As illustrated in FIG. 18, when each of the plurality of solid electrolyte islands 21 has a round shape, the maximum size Lₘₐₓ of each of the plurality of solid electrolyte islands 21 is the diameter of each of the plurality of solid electrolyte islands 21.

The interval between two solid electrolyte islands 21 adjacent to each other may be smaller than the maximum size Lₘₐₓ of each of the plurality of solid electrolyte islands 21. Thus, the plurality of solid electrolyte islands 21 can be arranged at high density.

The insulating layer 23 is provided on the insulating layer 14, on a side surface of the gas introduction path 15, on the first porous electrode 16, and on each of the plurality of solid electrolyte islands 21. The insulating layer 23 is, for example, a stacked layer of a tantalum pentoxide (Ta₂O₅) layer and a silicon dioxide (SiO₂) layer. The insulating layer 24 is provided on the insulating layer 23. The insulating layer 24 is, for example, a titanium dioxide (TiO₂) layer. Openings are provided on the insulating layer 23 and the insulating layer 24. An upper surface of each of the plurality of solid electrolyte islands 21 is exposed from the insulating layer 23 and the insulating layer 24. The upper surface of each of the plurality of solid electrolyte islands 21 is a surface of each of the plurality of solid electrolyte islands 21 distal to the first porous electrode 16 or proximal to the second porous electrode 25.

The second porous electrode 25 is provided on the plurality of solid electrolyte islands 21. The second porous electrode 25 is provided across the plurality of solid electrolyte islands 21. The second porous electrode 25 is in contact with each of the plurality of solid electrolyte islands 21. Particularly, the second porous electrode 25 is provided on the upper surface of each of the plurality of solid electrolyte islands 21. The second porous electrode 25 is provided in the openings provided on the insulating layer 23 and the insulating layer 24. The second porous electrode 25 is also provided on the insulating layer 24. The second porous electrode 25 is provided between the plurality of solid electrolyte islands 21 and the gas discharge path 27. The second porous electrode 25 easily passes the gas to be measured toward the gas discharge path 27. The second porous electrode 25 is formed by, for example, platinum (Pt) or palladium (Pd).

The gas discharge path 27 is provided on the second porous electrode 25. The gas discharge path 27 is extended from a part of the second porous electrode 25 facing the plurality of solid electrolyte islands 21 to an outlet (not illustrated) of the gas to be measured. The gas discharge path 27 may be formed by a second porous transition metal oxide with a fourth melting point higher than the first melting point of the first porous electrode 16. The gas discharge path 27 may be formed by a second porous transition metal oxide with a fourth melting point higher than the third melting point of the second porous electrode 25. The second porous transition metal oxide is, for example, tantalum pentoxide (Ta₂O₅), titanium dioxide (TiO₂), or chromium oxide (III) (Cr₂O₃).

The insulating layer 28 is provided on the gas discharge path 27, the second porous electrode 25, and the insulating layer 24. The insulating layer 28 is, for example, a stacked layer of a tantalum pentoxide (Ta₂O₅) layer and a silicon dioxide (SiO₂) layer. The insulating layer 28 functions as a protection layer that protects the gas discharge path 27 and the second porous electrode 25.

The plurality of solid electrolyte islands 21, the part of the first porous electrode 16 facing the plurality of solid electrolyte islands 21, and the part of the second porous electrode 25 facing the plurality of solid electrolyte islands 21 provide a sensor part of the limiting current gas sensor 1. Because of the opening 4a of the substrate 4, the sensor part of the limiting current gas sensor 1 is formed as a beam structure in which both ends are supported by the substrate 4. This can reduce the heat capacity of the sensor part and improve the sensor sensitivity.

A support that supports the sensor part includes a multi-layer structure of the insulating layers 5, 7, 10, and 14 and the nitride layers 6 and 11, that is, a multi-layer structure of silicon dioxide (SiO₂) layers and silicon nitride (Si₃N₄) layers, in addition to the substrate 4, the heater 9, and the temperature sensor 13. The thermal expansion coefficient of the multi-layer structure is closer to the thermal expansion coefficient of the heater 9 (for example, thermal expansion coefficient of platinum) than to the thermal expansion coefficient of silicon dioxide (SiO₂). This can reduce the thermal stress applied to the limiting current gas sensor 1 while the heater 9 heats the sensor part to operate the limiting current gas sensor 1.

An example of a manufacturing method of the limiting current gas sensor 1 according to the present embodiment will be described with reference to FIGS. 1 to 13. The manufacturing method of the limiting current gas sensor 1 according to the present embodiment mainly includes forming a support structure; forming the first porous electrode 16 including the main surface 16a on a surface 15a of the support structure; and forming the plurality of solid electrolyte islands 21 separated from each other, on the main surface 16a of the first porous electrode 16. The manufacturing method of the limiting current gas sensor 1 according to the present embodiment may further include forming the second porous electrode 25; and forming the gas discharge path 27.

The formation of the support structure in the manufacturing method of the limiting current gas sensor 1 according to the present embodiment will be described with reference to FIGS. 3 to 7. The support structure includes the substrate 4, the heater 9, the temperature sensor 13, the insulating layers 5, 7, 10, and 14, the nitride layers 6 and 11, the adhesive layers 8a, 8b, and 12, and a gas introduction path material layer 15p.

In FIG. 3, a chemical vapor deposition (CVD) method is used to form the insulating layer 5 on the main surface 4m of the substrate 4. The substrate 4 is, for example, a silicon substrate. The insulating layer 5 is formed by, for example, silicon dioxide (SiO₂). The CVD method is used to form the nitride layer 6 on the insulating layer 5. The nitride layer 6 is formed by, for example, silicon nitride (Si₃N₄). The CVD method is used to form the insulating layer 7 on the nitride layer 6. The insulating layer 7 is formed by, for example, silicon dioxide (SiO₂).

In FIG. 4, the heater 9 is formed. Specifically, a sputtering method is used to form a metal oxide layer (not illustrated), such as titanium oxide, chromium oxide, tungsten oxide, molybdenum oxide, and tantalum oxide, on the insulating layer 7. A photoresist (not illustrated) is formed on the metal oxide layer. A photolithography method is used to pattern the photoresist. The patterned photoresist is used to pattern the metal oxide layer. The adhesive layer 8a is obtained in this way.

The sputtering method is next used to form a metal layer (not illustrated), such as a platinum layer, on the adhesive layer 8a and the insulating layer 7. A photoresist (not illustrated) is formed on the metal layer. The photolithography method is used to pattern the photoresist. The patterned photoresist is used to pattern the metal layer. The heater 9 is obtained in this way. The heater 9 may be meandering in plan view of the main surface 4m of the substrate 4, and the heater 9 may be a meander heater wire.

The sputtering method is then used to form a metal oxide layer (not illustrated), such as titanium oxide, chromium oxide, tungsten oxide, molybdenum oxide, and tantalum oxide, on the insulating layer 7, the adhesive layer 8a, and the heater 9. A photoresist (not illustrated) is formed on the metal oxide layer. The photolithography method is used to pattern the photoresist. The patterned photoresist is used to pattern the metal oxide layer. The adhesive layer 8b is obtained in this way. The heater 9 is covered by the adhesive layers 8a and 8b in the cross section perpendicular to the longitudinal direction of the heater 9.

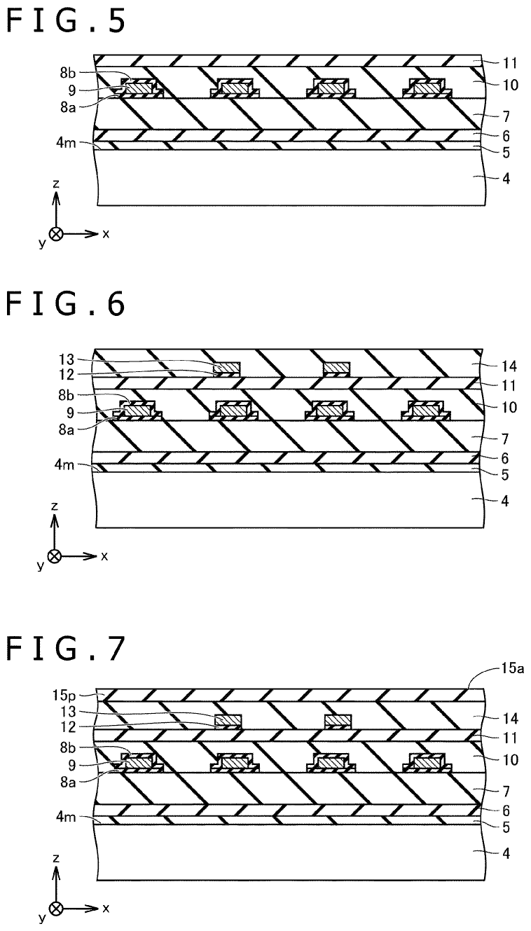

In FIG. 5, the CVD method is used to form the insulating layer 10 on the insulating layer 7 and the adhesive layers 8a and 8b. The heater 9 is embedded into the insulating layer 10. The insulating layer 10 is formed by, for example, silicon dioxide (SiO₂). The CVD method is used to form the nitride layer 11 on the insulating layer 10. The nitride layer 11 is formed by, for example, silicon nitride (Si₃N₄).

In FIG. 6, the temperature sensor 13 is formed. Specifically, the sputtering method is used to form a metal oxide layer (not illustrated), such as titanium oxide, chromium oxide, tungsten oxide, molybdenum oxide, and tantalum oxide, on the nitride layer 11. A photoresist (not illustrated) is formed on the metal oxide layer. The photolithography method is used to pattern the photoresist. The patterned photoresist is used to pattern the metal oxide layer. The adhesive layer 12 is obtained in this way.

The sputtering method is next used to form a metal layer (not illustrated), such as a platinum layer, on the nitride layer 11 and the adhesive layer 12. A photoresist (not illustrated) is formed on the metal layer. The photolithography method is used to pattern the photoresist. The patterned photoresist is used to pattern the metal layer. The temperature sensor 13 is obtained in this way.

Then, the CVD method is used to form the insulating layer 14 on the nitride layer 11, the adhesive layer 12, and the temperature sensor 13. The temperature sensor 13 is embedded into the insulating layer 14. The insulating layer 14 is formed by, for example, silicon dioxide (SiO₂).

In FIG. 7, the gas introduction path material layer 15p is formed on the insulating layer 14. The gas introduction path material layer 15p is a porous layer. Particularly, the gas introduction path material layer 15p is formed by the first porous transition metal oxide. The first porous transition metal oxide is, for example, tantalum pentoxide (Ta₂O₅), titanium dioxide (TiO₂), or chromium oxide (III) (Cr₂O₃). The gas introduction path material layer 15p is formed by, for example, an oblique deposition method. In another example, powder of the transition metal oxide is sintered to form the gas introduction path material layer 15p.

The support structure including the substrate 4, the heater 9, the temperature sensor 13, the insulating layers 5, 7, 10, and 14, the nitride layers 6 and 11, the adhesive layers 8a, 8b, and 12, and the gas introduction path material layer 15p is formed in this way. The support structure includes the surface 15a. The surface 15a of the support structure is, for example, a surface of the gas introduction path material layer 15p distal to the substrate 4.

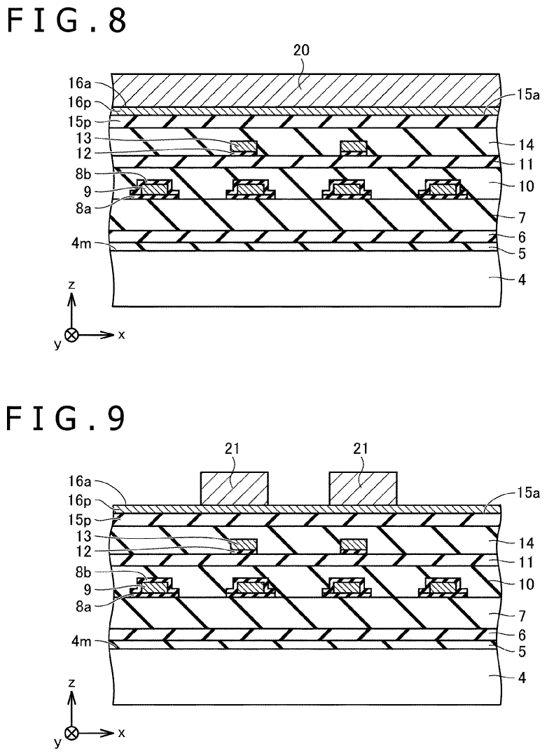

The formation of the first porous electrode 16 including the main surface 16a and the formation of the plurality of solid electrolyte islands 21 on the main surface 16a of the first porous electrode 16 in the manufacturing method of the limiting current gas sensor 1 according to the present embodiment will be described with reference to FIGS. 8 to 10. The formation of the first porous electrode 16 including the main surface 16a includes forming the first porous electrode material layer 16p on the entire surface 15a of the support structure; and etching (patterning) the first porous electrode material layer 16p to form the first porous electrode 16. The formation of the plurality of solid electrolyte islands 21 on the main surface 16a of the first porous electrode 16 includes forming the solid electrolyte material layer 20 on the first porous electrode material layer 16p; and etching (patterning) the solid electrolyte material layer 20 to form the plurality of solid electrolyte islands 21.

Specifically, the first porous electrode material layer 16p including the main surface 16a is formed on the surface 15a of the support structure in FIG. 8. The main surface 16a of the first porous electrode material layer 16p is a surface of the first porous electrode material layer 16p distal to the surface 15a of the support structure. Specifically, the first porous electrode material layer 16p is formed on the gas introduction path material layer 15p. Particularly, the first porous electrode material layer 16p is formed on the entire surface 15a of the support structure. In other words, the entire surface 15a of the support structure is covered by the first porous electrode material layer 16p. The first porous electrode material layer 16p is a porous metal layer. The first porous electrode material layer 16p is formed by, for example, platinum (Pt) or palladium (Pd). The first porous electrode material layer 16p is formed by, for example, the sputtering method.

In FIG. 8, the solid electrolyte material layer 20 is formed on the first porous electrode material layer 16p. The solid electrolyte material layer 20 is, for example, a layer in which a stabilizer, such as CaO, MgO, Y₂O₃, and Yb₂O₃, is added to a base material, such as ZrO₂, HfO₂, ThO₂, and Bi₂O₃. Particularly, the solid electrolyte material layer 20 is formed by yttria stabilized zirconia (YSZ). The solid electrolyte material layer 20 is formed by, for example, the sputtering method.

In FIG. 9, the solid electrolyte material layer 20 is etched to form the plurality of solid electrolyte islands 21 on the first porous electrode material layer 16p. The solid electrolyte material layer 20 is patterned by, for example, plasma etching using a boron trichloride (BCl₃) gas. The maximum size Lₘₐₓ (see FIGS. 2 and 18) of each of the plurality of solid electrolyte islands 21 in plan view of the main surface 16a of the first porous electrode 16 is equal to or smaller than 50√2 μm. In the etching (patterning) of the solid electrolyte material layer 20, the first porous electrode material layer 16p functions as an etch stop layer and prevents the support structure from being etched.

In FIG. 10, the first porous electrode material layer 16p and the gas introduction path material layer 15p are etched to form the first porous electrode 16 and the gas introduction path 15. The first porous electrode material layer 16p is patterned by, for example, plasma etching using a mixed gas of argon and oxygen. The gas introduction path material layer 15p is patterned by, for example, plasma etching using a chlorine gas. The first porous electrode 16 is formed across the plurality of solid electrolyte islands 21. The main surface 16a of the first porous electrode 16 is the main surface 16a of the first porous electrode material layer 16p. The first porous electrode 16 is in contact with each of the plurality of solid electrolyte islands 21.

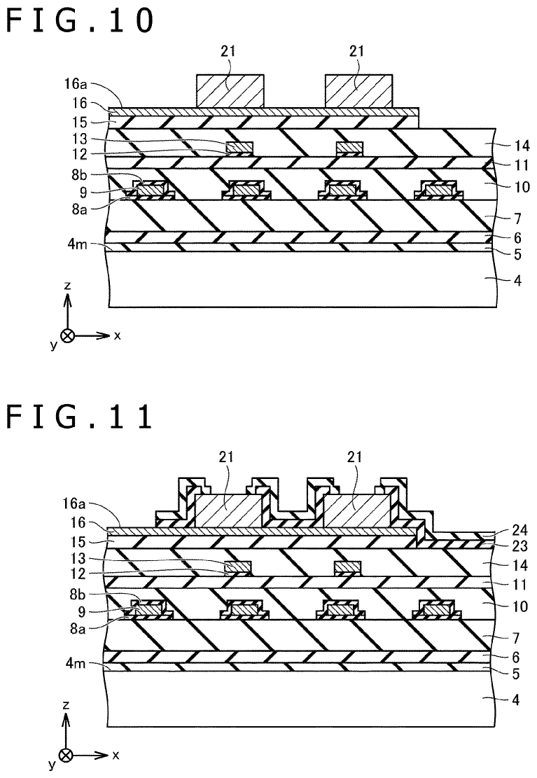

The formation of the second porous electrode 25 on the plurality of solid electrolyte islands 21 and the formation of the gas discharge path 27 on the second porous electrode 25 in the manufacturing method of the limiting current gas sensor 1 according to the present embodiment will be described with reference to FIGS. 11 to 13.

Specifically, the insulating layer 23 is formed on the insulating layer 14, on the side surface of the gas introduction path 15, on the first porous electrode 16, and on the plurality of solid electrolyte islands 21 in FIG. 11. The insulating layer 23 is formed by, for example, the sputtering method. The insulating layer 23 is, for example, a stacked layer of a tantalum pentoxide (Ta₂O₅) layer and a silicon dioxide (SiO₂) layer. The insulating layer 23 is etched to form an opening. Then, the sputtering method is used to form the insulating layer 24 on the insulating layer 23 and the plurality of solid electrolyte islands 21. The insulating layer 24 is, for example, a titanium dioxide (TiO₂) layer. The insulating layer 24 is etched to form an opening. The upper surface of each of the plurality of solid electrolyte islands 21 is exposed from the insulating layers 23 and 24.

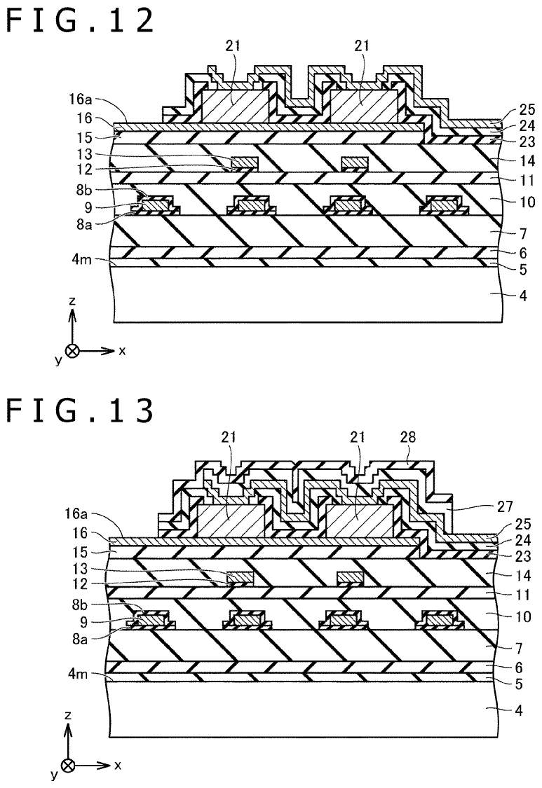

In FIG. 12, the second porous electrode 25 is formed on the plurality of solid electrolyte islands 21 and the insulating layer 24. The second porous electrode 25 is formed across the plurality of solid electrolyte islands 21. The second porous electrode 25 is in contact with each of the plurality of solid electrolyte islands 21. The second porous electrode 25 is formed by, for example, platinum (Pt) or palladium (Pd). The second porous electrode 25 is formed by, for example, the sputtering method.

In FIG. 13, the gas discharge path 27 is formed on the second porous electrode 25. The gas discharge path 27 is a porous layer. Particularly, the gas discharge path 27 is formed by the second porous transition metal oxide. The second porous transition metal oxide is tantalum pentoxide (Ta₂O₅), titanium dioxide (TiO₂), or chromium oxide (III) (Cr₂O₃). In one example, the gas discharge path 27 is formed by applying the oblique deposition method to the transition metal oxide. In another example, powder of the transition metal oxide is sintered to form the gas discharge path 27.

In FIG. 13, the insulating layer 28 is formed on the gas discharge path 27, the second porous electrode 25, and the insulating layer 24. The insulating layer 28 is, for example, a stacked layer of a tantalum pentoxide (Ta₂O₅) layer and a silicon dioxide (SiO₂) layer. The insulating layer 28 functions as a protection layer that protects the gas discharge path 27 and the second porous electrode 25.

Then, the substrate 4 is etched to form the opening 4a on the substrate 4. The heater 9 is surrounded by the edge of the opening 4a in plan view of the main surface 4m of the substrate 4. The limiting current gas sensor 1 illustrated in FIGS. 1 and 2 is obtained in this way.

An example in which the gas to be measured is exhaust gas of a car and the component gas included in the gas to be measured is nitrogen oxides (NOₓ) will be illustrated to describe the operation of the limiting current gas sensor 1 with reference to FIGS. 1, 2, and 14.

The gas to be measured flows from a gas inlet (not illustrated) to the plurality of solid electrolyte islands 21 through the gas introduction path 15 and the first porous electrode 16. The gas introduction path 15 restricts the flow rate per unit time of the gas to the plurality of solid electrolyte islands 21. The first porous electrode 16 decomposes nitric oxide (NO) that makes up most of the nitrogen oxides (NOₓ) included in the gas to be measured into nitrogen (N₂) and oxygen (O₂).

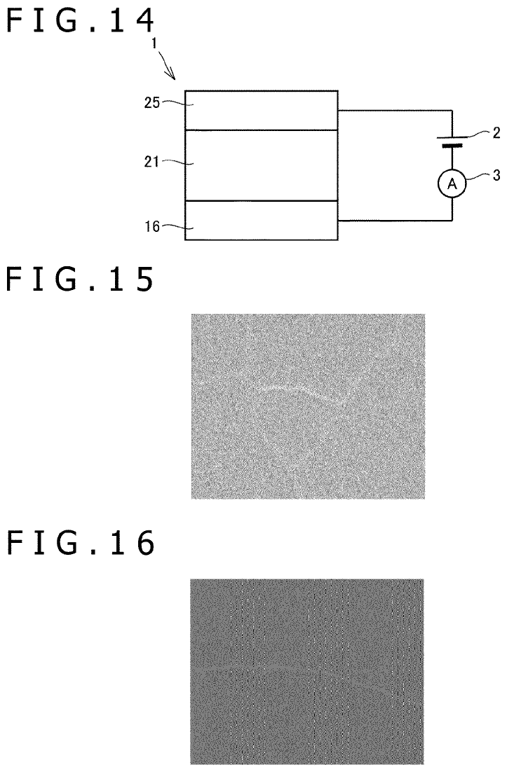

As illustrated in FIG. 14, the first porous electrode 16 is connected to a negative electrode of a voltage source 2. Electrons supplied from the voltage source 2 are received at the interface between the first porous electrode 16 and the plurality of solid electrolyte islands 21, and the oxygen (O₂) is converted into oxygen ions (2O²⁻). The heater 9 is used to heat the plurality of solid electrolyte islands 21 at a temperature of, for example, equal to or higher than 400° C. but equal to or lower than 750° C. The oxygen ions are conducted from the lower surface of the plurality of solid electrolyte islands 21 to the upper surface of the plurality of solid electrolyte islands 21. A current flows between the first porous electrode 16 and the second porous electrode 25 due to the conduction of the oxygen ions.

The gas introduction path 15 restricts the flow rate of the gas to be measured to the plurality of solid electrolyte islands 21. Thus, the current flowing between the first porous electrode 16 and the second porous electrode 25 is constant even if the voltage between the first porous electrode 16 and the second porous electrode 25 is increased. The constant current is called a limiting current. The limiting current value is proportional to the concentration of the component gas (for example, nitrogen oxides (NOₓ)) included in the gas to be measured (for example, exhaust gas). A current detector 3 measures the limiting current value. The concentration of the component gas included in the gas to be measured is obtained from the limiting current value. The voltage source 2 may be a variable voltage source. The magnitude of the voltage applied between the first porous electrode 16 and the second porous electrode 25 can be changed to obtain another limiting current value corresponding to another component gas (for example, water vapor (H₂O) or oxygen (O₂)) included in the gas to be measured. The concentration of the other component gas (for example, water vapor (H₂O) or oxygen (O₂)) can be obtained from the other limiting current value.

At the interface of the second porous electrode 25 and the plurality of solid electrolyte islands 21, the electrons are taken away from the oxygen ions (2O²⁻) reaching the second porous electrode 25, and the oxygen ions (2O²⁻) are converted into oxygen (O₂). The gas, such as oxygen (O₂), is discharged from a gas outlet (not illustrated) through the second porous electrode 25 and the gas discharge path 27.

A first comparison example and a second comparison example as examples of the limiting current gas sensor 1 according to the present embodiment will be compared to describe the action of the limiting current gas sensor 1 according to the present embodiment, with reference to FIGS. 15 to 17.

Although the limiting current gas sensor of the first comparison example has a configuration similar to that of the limiting current gas sensor 1 of the embodiment, the limiting current gas sensor is different from the limiting current gas sensor 1 of the embodiment in that the solid electrolyte layer of the first comparison example is not divided into a plurality of solid electrolyte islands 21. As illustrated in an SEM photo (magnification of 5000 times) of FIG. 15, the surface of the solid electrolyte layer is cracked when the limiting current gas sensor of the first comparison example is annealed at 700° C. that is within the operation temperature range of the limiting current gas sensor. Part of the gas to be measured flowing through the solid electrolyte layer in the normal direction (that is, from the lower surface of the solid electrolyte layer to the upper surface of the solid electrolyte layer) may pass through the crack and may flow through the solid electrolyte layer in the opposite direction (that is, from the upper surface of the solid electrolyte layer to the lower surface of the solid electrolyte layer).

The limiting current gas sensor of the first comparison example outputs the limiting current value based on the gas to be measured flowing through the solid electrolyte layer in the normal direction and the gas to be measured flowing through the solid electrolyte layer in the opposite direction. Thus, the concentration of the gas to be measured is not accurately reflected in the limiting current value output from the limiting current gas sensor of the first comparison example. Accurate concentration of the gas to be measured cannot be obtained on the basis of the limiting current value output from the limiting current gas sensor of the first comparison example.

Although the limiting current gas sensor of the second comparison example has a configuration similar to that of the limiting current gas sensor 1 of the embodiment, the limiting current gas sensor is different from the limiting current gas sensor 1 of the embodiment in that the maximum size Lₘₐₓ of each of the plurality of solid electrolyte islands 21 of the second comparison example is 80√2 μm. As illustrated in an SEM photo (magnification of 5000 times) of FIG. 16, the surface of one of the plurality of solid electrolyte islands 21 is cracked when the limiting current gas sensor of the second comparison example is annealed at 700° C. that is within the operation temperature range of the limiting current gas sensor. For a reason similar to the reason in the limiting current gas sensor of the first comparison example, accurate concentration of the gas to be measured cannot be obtained on the basis of the limiting current value output from the limiting current gas sensor of the second comparison example.

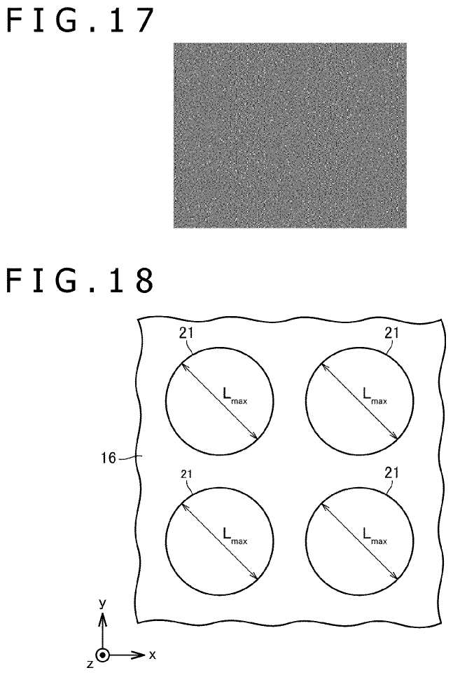

On the other hand, the maximum size Lₘₐₓ of each of the plurality of solid electrolyte islands 21 is 50√2 μm in the limiting current gas sensor 1 of the embodiment. As illustrated in an SEM photo (magnification of 5000 times) of FIG. 17, the surface of each of the plurality of solid electrolyte islands 21 is not cracked even when the limiting current gas sensor 1 of the embodiment is annealed at 700° C. that is within the operation temperature range of the limiting current gas sensor 1. The limiting current gas sensor 1 of the embodiment outputs the limiting current value based on the gas to be measured flowing through the solid electrolyte layer in the normal direction. Thus, the concentration of the gas to be measured is accurately reflected in the limiting current value output from the limiting current gas sensor 1 of the embodiment. Accurate concentration of the gas to be measured can be obtained on the basis of the limiting current value output from the limiting current gas sensor 1 of the embodiment.

The reason that each of the plurality of solid electrolyte islands 21 is not cracked in the present embodiment may be as follows. Thermal stress is applied to the plurality of solid electrolyte islands 21 when the temperature of the limiting current gas sensor 1 is raised to the operating temperature of the limiting current gas sensor 1. However, the maximum size Lₘₐₓ of each of the plurality of solid electrolyte islands 21 is equal to or smaller than 50√2 μm in the limiting current gas sensor 1 of the present embodiment. The thermal stress applied to each of the plurality of solid electrolyte islands 21 can be reduced in the present embodiment, and thus, each of the plurality of solid electrolyte islands 21 is not cracked. On the other hand, larger thermal stress is applied to the solid electrolyte layer of the first comparison example and the plurality of solid electrolyte islands 21 of the second comparison example, and thus, the solid electrolyte layer of the first comparison example and the plurality of solid electrolyte islands 21 of the second comparison example are cracked.

Effects of the limiting current gas sensor 1 and the manufacturing method thereof of the present embodiment will be described.

The limiting current gas sensor 1 of the present embodiment includes the first porous electrode 16, the plurality of solid electrolyte islands 21, and the second porous electrode 25. The first porous electrode 16 includes the main surface 16a. The plurality of solid electrolyte islands 21 are provided on the main surface 16a of the first porous electrode 16 and separated from each other. The second porous electrode 25 is provided on the plurality of solid electrolyte islands 21. The first porous electrode 16 is provided across the plurality of solid electrolyte islands 21. The second porous electrode 25 is provided across the plurality of solid electrolyte islands 21. The maximum size of each of the plurality of solid electrolyte islands 21 in plan view of the main surface 16a of the first porous electrode 16 is equal to or smaller than 50√2 μm.

Thus, the thermal stress applied to each of the plurality of solid electrolyte islands 21 can be reduced during the operation of the limiting current gas sensor 1, and the occurrence of a crack in each of the plurality of solid electrolyte islands 21 can be prevented. According to the limiting current gas sensor 1, more accurate concentration of the gas to be measured can be obtained.

In the limiting current gas sensor 1 of the present embodiment, each of the plurality of solid electrolyte islands 21 has a thickness of equal to or smaller than 2.0 μm.

Thus, the thermal stress applied to each of the plurality of solid electrolyte islands 21 can be reduced during the operation of the limiting current gas sensor 1, and the occurrence of a crack in each of the plurality of solid electrolyte islands 21 can be prevented. According to the limiting current gas sensor 1, more accurate concentration of the gas to be measured can be obtained.

In the limiting current gas sensor 1 of the present embodiment, each of the plurality of solid electrolyte islands 21 has a thickness of equal to or greater than 0.8 μm.

Thus, a plurality of precise and high-quality solid electrolyte islands 21 can be formed on the first porous electrode 16. According to the limiting current gas sensor 1, more accurate concentration of the gas to be measured can be obtained.

In the limiting current gas sensor 1 of the present embodiment, each of the plurality of solid electrolyte islands 21 has a rectangular shape in plan view of the main surface 16a of the first porous electrode 16.

Thus, the plurality of solid electrolyte islands 21 can be arranged at high density on the first porous electrode 16. The ratio of the area of the plurality of solid electrolyte islands 21 to the area of the first porous electrode 16 can be increased. The sensitivity of the limiting current gas sensor 1 can thus be improved.

In the limiting current gas sensor 1 of the present embodiment, each of the plurality of solid electrolyte islands 21 has a round shape in plan view of the main surface 16a of the first porous electrode 16.

Each of the plurality of solid electrolyte islands 21 does not have corners, and thus, the concentration of the thermal stress is alleviated in each of the plurality of solid electrolyte islands 21. The occurrence of a crack in each of the plurality of solid electrolyte islands 21 can be prevented during the operation of the limiting current gas sensor 1. According to the limiting current gas sensor 1, more accurate concentration of the gas to be measured can be obtained.

In the limiting current gas sensor 1 of the present embodiment, the plurality of solid electrolyte islands 21 are two-dimensionally and periodically arranged in plan view of the main surface 16a of the first porous electrode 16.

Thus, the plurality of solid electrolyte islands 21 can be arranged at high density. The sensitivity of the limiting current gas sensor 1 can be improved.

In the limiting current gas sensor 1 of the present embodiment, the plurality of solid electrolyte islands 21 are arranged in a grid pattern or a staggered pattern in plan view of the main surface 16a of the first porous electrode 16.

Thus, the plurality of solid electrolyte islands 21 can be arranged at high density. For example, when each of the plurality of solid electrolyte islands 21 has a square shape in plan view of the main surface 16a of the first porous electrode 16, the plurality of solid electrolyte islands 21 are arranged in a grid pattern and can thus be arranged at high density. When each of the plurality of solid electrolyte islands 21 has a round shape in plan view of the main surface 16a of the first porous electrode 16, the plurality of solid electrolyte islands 21 are arranged in a staggered pattern and can thus be arranged at high density. The sensitivity of the limiting gas sensor 1 can thus be improved.

The manufacturing method of the limiting current gas sensor 1 according to the present embodiment includes forming the first porous electrode 16 including the main surface 16a; forming the plurality of solid electrolyte islands 21 separated from each other, on the main surface 16a of the first porous electrode 16; and forming the second porous electrode 25 on the plurality of solid electrolyte islands 21. The first porous electrode 16 is formed across the plurality of solid electrolyte islands 21. The second porous electrode 25 is formed across the plurality of solid electrolyte islands 21. The maximum size of each of the plurality of solid electrolyte islands 21 in plan view of the main surface 16a of the first porous electrode 16 is equal to or smaller than 50√2 μm.

Thus, the thermal stress applied to each of the plurality of solid electrolyte islands 21 can be reduced during the operation of the limiting current gas sensor 1, and the occurrence of a crack in each of the plurality of solid electrolyte islands 21 can be prevented. The limiting current gas sensor 1 that can obtain more accurate concentration of the gas to be measured can be manufactured.

In the manufacturing method of the limiting current gas sensor 1 according to the present embodiment, the formation of the first porous electrode 16 includes forming the first porous electrode material layer 16p on the entire surface 15a of the support structure; and etching the first porous electrode material layer 16p to form the first porous electrode 16. The main surface 16a of the first porous electrode 16 is a surface of the first porous electrode 16 distal to the surface 15a of the support structure. The formation of the plurality of solid electrolyte islands 21 on the main surface 16a of the first porous electrode 16 includes forming the solid electrolyte material layer 20 on the first porous electrode material layer 16p; and etching the solid electrolyte material layer 20 on the first porous electrode material layer 16p, to form the plurality of solid electrolyte islands 21.

Thus, in etching the solid electrolyte material layer 20, the first porous electrode material layer 16p functions as an etch step layer and prevents the support structure from being etched. The limiting current gas sensor 1 that can obtain more accurate concentration of the gas to be measured can thereby be manufactured.

The embodiment and the modification of the embodiment disclosed here are illustrative in all aspects and should not be construed as being restrictive. The scope of the present disclosure is indicated by the claims rather than the description, and all changes within the meaning and range of equivalents of the claims are intended to be included in the scope of the present disclosure.

The present disclosure contains subject matter related to that disclosed in Japanese Priority Patent

What is claimed is:

1. A limiting current gas sensor comprising:
a first porous electrode including a main surface;
a plurality of solid electrolyte islands provided on the main surface of the first porous electrode and separated from each other; and
a second porous electrode provided on the plurality of solid electrolyte islands, wherein
the first porous electrode is provided across the plurality of solid electrolyte islands,
the second porous electrode is provided across the plurality of solid electrolyte islands, and
a maximum size of each of the plurality of solid electrolyte islands in plan view of the main surface is equal to or smaller than 50√2 μm.

2. The limiting current gas sensor according to claim 1, wherein
each of the plurality of solid electrolyte islands has a thickness of equal to or smaller than 2.0 μm.

3. The limiting current gas sensor according to claim 1, wherein
each of the plurality of solid electrolyte islands has a thickness of equal to or greater than 0.8 μm.

4. The limiting current gas sensor according to claim 1, wherein
each of the plurality of solid electrolyte islands has a rectangular shape in the plan view of the main surface.

5. The limiting current gas sensor according to claim 1, wherein
each of the plurality of solid electrolyte islands has a round shape in the plan view of the main surface.

6. The limiting current gas sensor according to claim 1, wherein
the plurality of solid electrolyte islands are two-dimensionally and periodically arranged in the plan view of the main surface.

7. The limiting current gas sensor according to claim 6, wherein
the plurality of solid electrolyte islands are arranged in a grid pattern or a staggered pattern in the plan view of the main surface.

8. A manufacturing method of a limiting current gas sensor, the manufacturing method comprising:
forming a first porous electrode including a main surface;
forming a plurality of solid electrolyte islands separated from each other, on the main surface of the first porous electrode; and
forming a second porous electrode on the plurality of solid electrolyte islands, wherein
the first porous electrode is formed across the plurality of solid electrolyte islands,
the second porous electrode is formed across the plurality of solid electrolyte islands, and
a maximum size of each of the plurality of solid electrolyte islands in plan view of the main surface is equal to or smaller than 50√2 μm.

9. The manufacturing method of the limiting current gas sensor according to claim 8, wherein
the forming the first porous electrode includes
forming a first porous electrode material layer on an entire surface of a support structure, and
etching the first porous electrode material layer to form the first porous electrode,
the main surface of the first porous electrode is a surface of the first porous electrode distal to the surface of the support structure, and
the forming the plurality of solid electrolyte islands on the main surface of the first porous electrode includes
forming a solid electrolyte material layer on the first porous electrode material layer, and
etching the solid electrolyte material layer on the first porous electrode material layer, to form the plurality of solid electrolyte islands.
